(19) United States
(12) Patent Application Publication
(10) Pub. No.: US 2026/0111572 A1
(43) Pub. Date: Apr. 23, 2026

(54) VECTOR RETRIEVAL METHOD, APPARATUS, MEDIUM, ELECTRONIC DEVICE AND PROGRAM PRODUCT

(71) Applicant: Beijing Volcano Engine Technology Co., Ltd., Beijing (CN)

(72) Inventors: Daode ZHANG, Beijing (CN); Quanwei CAI, Beijing (CN); Yu LIN, Beijing (CN); Jue HONG, Beijing (CN); Ye WU, Beijing (CN)

(21) Appl. No.: 19/264,210

(22) Filed: Jul. 9, 2025

(30) Foreign Application Priority Data
Oct. 21, 2024 (CN) 202411472727.X

(51) Int. Cl. G06F 21/60; G06F 17/16

(52) U.S. Cl. CPC G06F 21/602; G06F 17/16

(57) ABSTRACT

A vector retrieval method and apparatus, a medium, an electronic device and a program product. The method includes: acquiring a target vector to be retrieved and a target key; performing linear transformation on the target vector by using the target random number; performing a rotation operation on the target vector obtained after the linear transformation by using the target orthogonal matrix to obtain a first ciphertext vector; and sending the first ciphertext vector to a first server, so that the first server retrieves at least one second ciphertext vector that is similar to the first ciphertext vector from a knowledge vector base, ciphertext vectors in the knowledge vector base are generated based on the target key and a reference vector, and a generation manner of the ciphertext vectors is the same as a generation manner of the first ciphertext vector.

### CROSS-REFERENCE TO RELATED APPLICATION

The present application claims priority of the Chinese Patent Application No. 202411472727.X, filed on Oct. 21, 2024, the disclosure of which is incorporated herein by reference in the present application.

### TECHNICAL FIELD

The present disclosure relates to the field of computer technologies, and in particular, to a vector retrieval method, an apparatus, a medium, an electronic device and a program product.

### BACKGROUND

An embedding vector (embedding) may be used to support applications such as vector retrieval, clustering, recommendation, etc. Among them, a typical application is retrieval-augmented generation (RAG), and its role in the entire process of a large language model is shown in FIG. 1. As shown in FIG. 1, there are two key stages of RAG: the first stage is a retrieval stage, which is used to encode a text corresponding to a user's input request to generate a query embedding, and then, compare the query embedding with an embedding in a knowledge vector base (for example, based on dense vector retrieval), to obtain a similar vector similar to the query embedding vector, and obtain a plaintext corresponding to the similar vector; and the second stage is a generation stage, that is, using the plaintext corresponding to the similar vector retrieved in the retrieval stage as prompt information, and inputting it into the large language model together with the text corresponding to the input request, to obtain a reply text of the text corresponding to the input request.

Generally, the embedding is considered to be unable to retrieve the original plaintext, so no security protection is performed on it (otherwise retrieval cannot be supported). In fact, as shown in FIG. 2, even if the attacker does not have an embedding model, the attacker can still retrieve the plaintext (i.e., the attack restoration text) from the embedding by using a vector-to-text (vec2text) attack, where the similarity between the retrieved plaintext and the original text is close to 1, which may leak the user's privacy. Therefore, it is necessary to protect the embedding stored in the knowledge vector base on the premise of supporting vector retrieval.

### SUMMARY

The Summary is provided to introduce concepts in a simplified form, and these concepts will be described in detail in the Detailed Description section below. The Summary is not intended to identify key features or essential features of the claimed technical solution, nor is it intended to be used to limit the scope of the claimed technical solution.

In a first aspect, the present disclosure provides a vector retrieval method, including:
acquiring a target vector to be retrieved and a target key, where the target key includes a target random number and a target orthogonal matrix;
performing linear transformation on the target vector by using the target random number;
performing a rotation operation on the target vector obtained after the linear transformation by using the target orthogonal matrix to obtain a first ciphertext vector; and
sending the first ciphertext vector to a first server, so that the first server retrieves at least one second ciphertext vector that is similar to the first ciphertext vector from a knowledge vector base, where ciphertext vectors in the knowledge vector base are generated based on the target key and a reference vector, and a generation manner of the ciphertext vectors is the same as a generation manner of the first ciphertext vector.

In a second aspect, the present disclosure provides a vector retrieval apparatus, including:
an acquiring module, configured to acquire a target vector to be retrieved and a target key, where the target key includes a target random number and a target orthogonal matrix;
a linear transformation module, configured to perform linear transformation on the target vector by using the target random number;
a rotation module, configured to perform a rotation operation on the target vector obtained after the linear transformation by using the target orthogonal matrix to obtain a first ciphertext vector; and
a first sending module, configured to send the first ciphertext vector to a first server, so that the first server retrieves at least one second ciphertext vector that is similar to the first ciphertext vector from a knowledge vector base, where ciphertext vectors in the knowledge vector base are generated based on the target key and a reference vector, and a generation manner of the ciphertext vectors is the same as a generation manner of the first ciphertext vector.

In a third aspect, the present disclosure provides a computer-readable medium, a computer program is stored on the computer-readable medium, and the computer program, when executed by a processing apparatus, implements steps of the vector retrieval method provided by the first aspect of the present disclosure.

In a fourth aspect, the present disclosure provides an electronic device, including:
a storage apparatus, a computer program is stored on the storage apparatus; and
a processing apparatus, configured to execute the computer program in the storage apparatus to implement steps of the vector retrieval method provided by the first aspect of the present disclosure.

In a fifth aspect, the present disclosure provides a computer program product, including a computer program, where the computer program, when executed by a processor, implements steps of the vector retrieval method provided by the first aspect of the present disclosure.

Other features and advantages of the present disclosure will be described in detail in the subsequent detailed description section.

### BRIEF DESCRIPTION OF DRAWINGS

The above and other features, advantages and aspects of the embodiments of the present disclosure will become more apparent with reference to the following detailed description and in conjunction with the drawings. Throughout the drawings, the same or similar reference numerals refer to the same or similar elements. It should be understood that the drawings are schematic and that the components and elements are not necessarily drawn to scale. In the drawings:

FIG. 1 is a schematic diagram of a process of a retrieval-augmented generation method in the related art;

FIG. 2 is a schematic diagram of a vec2text attack in the related art;

FIG. 3 is a flowchart of a vector retrieval method according to an exemplary embodiment;

FIG. 4 is a schematic diagram of a vec2text attack according to an exemplary embodiment;

FIG. 5 is a flowchart of a vector retrieval method according to another exemplary embodiment;

FIG. 6 is a flowchart of a vector retrieval method according to yet another exemplary embodiment;

FIG. 7 is a block diagram of a vector retrieval apparatus according to an exemplary embodiment; and

FIG. 8 is a schematic structural diagram of an electronic device according to an exemplary embodiment.

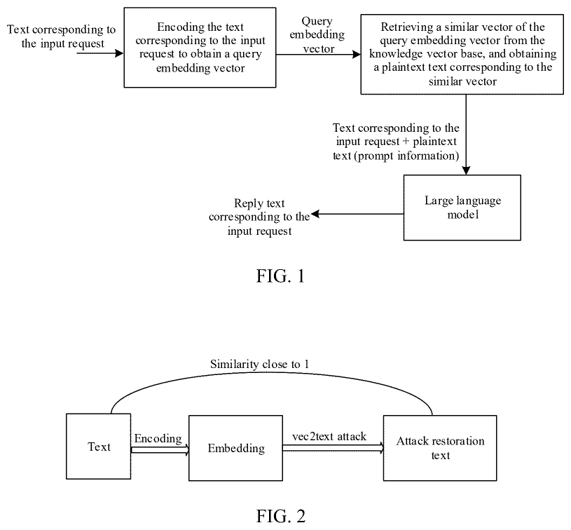

### DETAILED DESCRIPTION

Embodiments of the present disclosure will be described in more detail below with reference to the drawings. Although some embodiments of the present disclosure are shown in the drawings, it should be understood that the present disclosure may be implemented in various forms and should not be construed as limited to the embodiments set forth herein. Rather, these embodiments are provided for a thorough and complete understanding of the present disclosure. It should be understood that the drawings and embodiments of the present disclosure are only for illustrative purposes and are not intended to limit the protection scope of the present disclosure.

It should be understood that the various steps recited in the method implementations of the present disclosure may be performed in different order and/or in parallel. In addition, the method implementations may include additional steps and/or omit to perform the illustrated steps. The scope of the present disclosure is not limited in this respect.

As used herein, the term “include/comprise” and its variants are open-ended inclusions, that is, “include/comprise but not limited to”. The term “based on” is “based at least in part on”. The term “one embodiment” means “at least one embodiment”; the term “another embodiment” means “at least one another embodiment”; the term “some embodiments” means “at least some embodiments”. Related definitions of other terms will be given in the following description.

It should be noted that the concepts of “first” and “second” mentioned in the present disclosure are only used to distinguish between different apparatuses, modules or units, and are not used to limit the order or interdependence of functions performed by these apparatuses, modules or units.

It should be noted that the modifiers “one” and “a plurality of” mentioned in the present disclosure are illustrative rather than restrictive, and those skilled in the art should understand that unless the context clearly indicates otherwise, they should be understood as “one or more”.

The names of messages or information exchanged between the plurality of apparatuses in the implementations of the present disclosure are only used for illustrative purposes, and are not intended to limit the scope of these messages or information.

It should be understood that, before using the technical solutions disclosed in the embodiments of the present disclosure, the user should be informed of the type, usage scope, usage scenario, etc. of the personal information involved in the present disclosure and obtain the user's authorization through an appropriate manner according to relevant laws and regulations.

For example, in response to receiving an active request from the user, prompt information is sent to the user, so as to explicitly prompt the user that the operation requested to be performed will require the acquisition and use of the user's personal information. Thereby, the user can independently choose whether to provide personal information to software or hardware such as an electronic device, an application, a server, or a storage medium that performs the operation of the technical solution of the present disclosure according to the prompt information.

As an optional but not limiting implementation, the manner of sending the prompt information to the user in response to receiving the active request from the user may be, for example, a pop-up window, and the prompt information may be presented in the form of text in the pop-up window. In addition, the pop-up window may also carry a selection control for the user to select “agree” or “disagree” to provide personal information to the electronic device.

It should be understood that the above process of notifying and acquiring the user's authorization is only illustrative, and does not constitute a limitation to the implementations of the present disclosure, and other manners that meet relevant laws and regulations may also be applied to the implementations of the present disclosure.

Furthermore, it should be understood that data involved in the technical solution (including but not limited to the data itself, the acquisition or use of the data) should comply with the requirements of corresponding laws, regulations and related regulations.

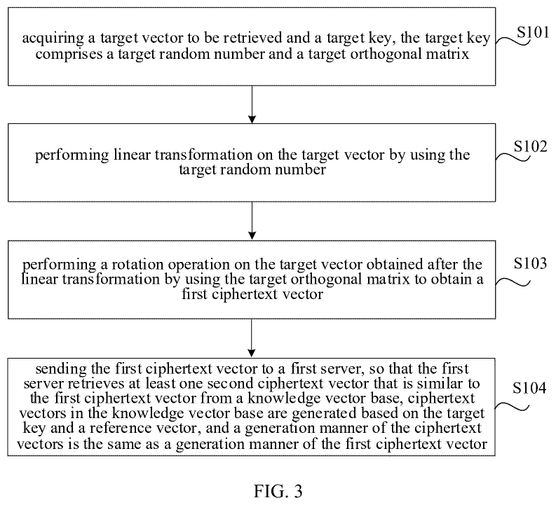

FIG. 3 is a flowchart of a vector retrieval method according to an exemplary embodiment. As shown in FIG. 3, the vector retrieval method may include the following steps of S101 to S104.

In S101, a target vector to be retrieved and a target key are acquired, and the target key includes a target random number and a target orthogonal matrix.

In the present disclosure, the above vector retrieval method may be applied to a client. For a question answering scenario, a user may input a request to the client, and the client may encode a text corresponding to the input request to obtain the target vector to be retrieved in response to receiving the input request. The target key may be pre-generated by the client, for example, pre-generating a random number as the target random number, and randomly generating an orthogonal matrix with a dimension of d as the target orthogonal matrix, where d is a dimension of the target vector, and d is a natural number greater than 0.

In S102, linear transformation is performed on the target vector by using the target random number.

Exemplarily, the target vector obtained after the linear transformation is c′=s·m, where s is the target random number, and m is the target vector.

In S103, a rotation operation is performed on the target vector obtained after the linear transformation by using the target orthogonal matrix to obtain a first ciphertext vector.

Exemplarily, the rotation operation may be performed on the target vector obtained after the linear transformation by using the following equation (1), to obtain the first ciphertext vector C:

$$c = M \cdot {c}^{′} \qquad ( 1 )$$

where M is a target orthogonal vector.

In S104, the first ciphertext vector is sent to a first server, so that the first server retrieves at least one second ciphertext vector that is similar to the first ciphertext vector from a knowledge vector base, where ciphertext vectors in the knowledge vector base are generated based on the target key and a reference vector, and a generation manner of the ciphertext vectors is the same as a generation manner of the first ciphertext vector.

In the present disclosure, the knowledge vector base is stored on the first server, and the knowledge vector base includes a plurality of ciphertext vectors and a ciphertext corresponding to each ciphertext vector, where the ciphertext vectors in the knowledge vector base are obtained by the client by performing linear transformation and rotation operation on the reference vector based on the target key, the reference vector may be a vector obtained by the client by performing word segmentation and encoding on a text in a corpus, and the ciphertext corresponding to the ciphertext vector is obtained by the client by performing symmetric encryption on a corresponding text in the corpus, for example, using an advanced encryption standard (AES) to encrypt the text, and the client stores the ciphertext vector and its corresponding ciphertext into the knowledge vector base after acquiring the ciphertext vector and its corresponding ciphertext. The generation manner of the ciphertext vectors in the knowledge vector base is the same as the generation manner of the first ciphertext vector, that is, first performing the linear transformation on the reference vector by using the target random number, and then performing the rotation operation on the reference vector obtained after the linear transformation by using the target orthogonal matrix, to obtain the ciphertext vector of the reference vector, that is, the ciphertext vector in the knowledge vector base.

After encrypting the target vector by using the linear transformation and the rotation operation, the client sends the first ciphertext vector obtained after the encryption to the first server. After receiving the first ciphertext vector sent by the client, the first server may retrieve at least one second ciphertext vector that is similar to the first ciphertext vector from the knowledge vector base by using an approximate nearest neighbors (ANN) algorithm, and feed back the at least one similar second ciphertext vector to the client. The first server may measure the similarity between the first ciphertext vector and each of the ciphertext vectors in the knowledge vector base by using a Euclidean distance, a cosine similarity, or the like, and determine a ciphertext vector of which similarity with the first ciphertext vector is greater than a preset similarity threshold as a vector similar to the first ciphertext vector.

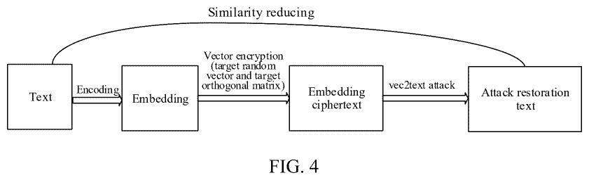

As shown in FIG. 4, the target random number and the target orthogonal matrix are used to encrypt both the target vector and each of the reference vectors in the knowledge vector base, which can mask the information of the original plaintext vectors from two directions, that is, a horizontal direction (linear transformation) and a vertical direction (orthogonal matrix), so that the similarity between the plaintext (i.e., the attack restoration text) retrieved by the vec2text attack and the original text (e.g., the text corresponding to the input request) is reduced, thereby the vec2text attack in the language model service scenario can be resisted, and the user's privacy leakage can be avoided.

In the above technical solution, before performing vector retrieval on the target vector, linear transformation is first performed on the target vector by using the target random number, and then the rotation operation is performed on the target vector obtained after the linear transformation by using the target orthogonal matrix, to obtain the first ciphertext vector of the target vector. Finally, the first ciphertext vector is sent to the first server, so that the first server retrieves the at least one second ciphertext vector that is similar to the first ciphertext vector from the knowledge vector base, where the ciphertext vectors in the knowledge vector base are generated based on the target random number, the target orthogonal matrix, and the reference vector, and the generation manner of the ciphertext vectors is the same as the generation manner of the first ciphertext vector. Since multiplying an orthogonal matrix by a vector has a characteristic of keeping the distance between vectors, performing the rotation operation on the target vector obtained after the linear transformation and the reference vector obtained after the linear transformation by using the orthogonal matrix can make the distance between the first ciphertext vector and the second ciphertext vector close to the distance between the original plaintext vectors, so as to approximately keep the distance between the plaintext vectors, so that retrieval on the ciphertext vectors can be supported as the plaintext vectors support retrieval, and the recall rate is basically unchanged. In addition, the target random number and the target orthogonal matrix are used to encrypt both the target vector and each of the reference vectors in the knowledge vector base, which can mask the information of the original plaintext vectors from two directions, that is, a horizontal direction (linear transformation) and a vertical direction (orthogonal matrix), so that the vec2text attack in the language model service scenario can be resisted and the user's privacy leakage can be avoided on the premise of supporting vector retrieval.

Since the target orthogonal matrix is fixed, if the first server obtains a plurality of original plaintext vectors and ciphertext vector corresponding to each of the respective original plaintext vectors, the target orthogonal matrix may be estimated, so as to retrieve the plaintext vectors corresponding to other ciphertext vectors, and then obtain the original texts corresponding to the plaintext vectors by using the vec2text attack. Therefore, noise addition processing may be performed on the target vector to enhance the privacy of the ciphertext vector, where the introduction of noise may make the relationship between the ciphertext vectors and the original plaintext vectors no longer a simple linear relationship, so that it is difficult to solve the noise in the ciphertext vector without knowing the key, and it is further difficult to solve the plaintext vector corresponding to the ciphertext vector, so as to resist the vec2text attack in the language model service scenario. Specifically, the above target key may further include a first bit string with a first preset length, where the client may randomly generate a bit string with the first preset length composed of 0 and 1, as the first bit string.

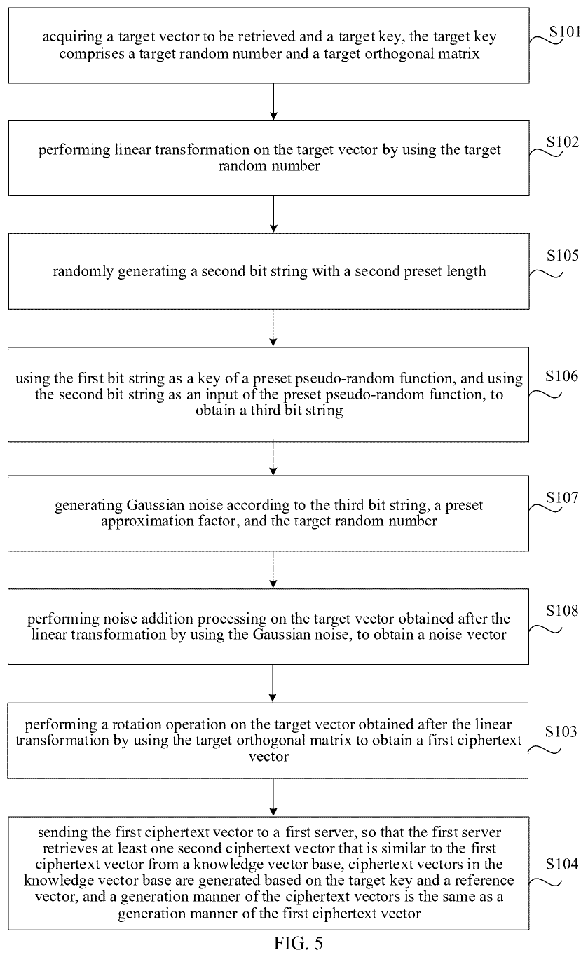

At this time, as shown in FIG. 5, before the above S103, the above vector retrieval method may further include the following steps of S105 to S108.

In S105, a second bit string with a second preset length is randomly generated.

In the present disclosure, the second bit string is a bit string with the second preset length composed of 0 and 1.

In S106, the first bit string is used as a key of a preset pseudo-random function, and the second bit string is used as an input of the preset pseudo-random function, to obtain a third bit string.

In S107, Gaussian noise is generated according to the third bit string, a preset approximation factor, and the target random number.

In S108, noise addition processing is performed on the target vector obtained after the linear transformation by using the Gaussian noise, to obtain a noise vector.

Exemplarily, the noise addition processing may be performed on the target vector obtained after the linear transformation by using the Gaussian noise by using the following equation (2), to obtain the noise vector:

$$z = {c}^{′} + {λ}_{m} \qquad ( 2 )$$

where z is the noise vector; and λₘ is the Gaussian noise.

At this time, the above S103 may perform the rotation operation on the noise vector by using the target orthogonal matrix, to obtain the first ciphertext vector.

Exemplarily, the rotation operation may be performed on the noise vector by using the following equation (3), to obtain the first ciphertext vector c:

$$c = M \cdot z \qquad ( 3 )$$

The detailed implementation of generating the Gaussian noise according to the third bit string, the preset approximation factor, and the target random number in the above S107 will be described in detail below. Specifically, it may be implemented by using the following steps (a1) to (a3).

Step (a1): the third bit string is split into a fourth bit string and a fifth bit string based on a preset splitting rule.

In the present disclosure, the preset splitting rule may be to equally split the third bit string into two bit strings with equal length, or to split the third bit string according to another ratio (for example, 3:7), which is not specifically limited in the present disclosure. In addition, when encrypting the reference vector, it is also based on the preset splitting rule.

Step (a2): a Gaussian vector with a dimension of d that conforms to a standard normal distribution is generated by using the fourth bit string, and a pseudo-random number that conforms to a uniform distribution of (0, 1) is generated by using the fifth bit string.

In the present disclosure, a Gaussian distribution algorithm may be used to generate the Gaussian vector that conforms to the standard normal distribution N (0, I_{d}) by using the fourth bit string as an input, where I_{d} is a d-dimensional identity matrix, and is a standard deviation.

Step (a3): the Gaussian noise is generated by using the Gaussian vector, the pseudo-random number, the preset approximation factor, and the target random number.

Exemplarily, the Gaussian noise may be generated by using the Gaussian vector, the pseudo-random number, the preset approximation factor, and the target random number by using the following equation (4):

$${λ}_{m} = γ \cdot s {β ( {x}^{′} )}^{1 / d} \cdot \frac{u}{‖ u ‖} \qquad ( 4 )$$

where γ is a scaling factor, which is a real number, and when the similarity between the first ciphertext vector and each of the ciphertext vectors in the knowledge vector base is measured by using the Euclidean distance, a value range of γ is (0,0.25], and when the similarity between the first ciphertext vector and each of the ciphertext vectors in the knowledge vector base is measured by using the cosine similarity, the value range of γ is

$$\frac{( 0 , \sqrt{20}}{2} - 2 ] ;$$

β is the preset approximation factor, and 0≤β<2W\sqrt{d}, the vector space of dimension d to which the target vector belongs α=[−W, W]^{d}, and a range of elements in the target vector belongs to [−W, W]; x′ is the pseudo-random number; u is the Gaussian vector; and ∥u∥ is a 2-norm of the Gaussian vector.

The smaller the privacy factor β, the higher the recall rate of the neighbor retrieval, but the worse the privacy protection of the original vector. The larger the privacy factor β, the lower the recall rate of the neighbor retrieval, but the better the privacy protection of the original vector. Therefore, the size of the privacy factor β may be adjusted to achieve a balance between the recall rate of the neighbor retrieval and the privacy protection of the original vector.

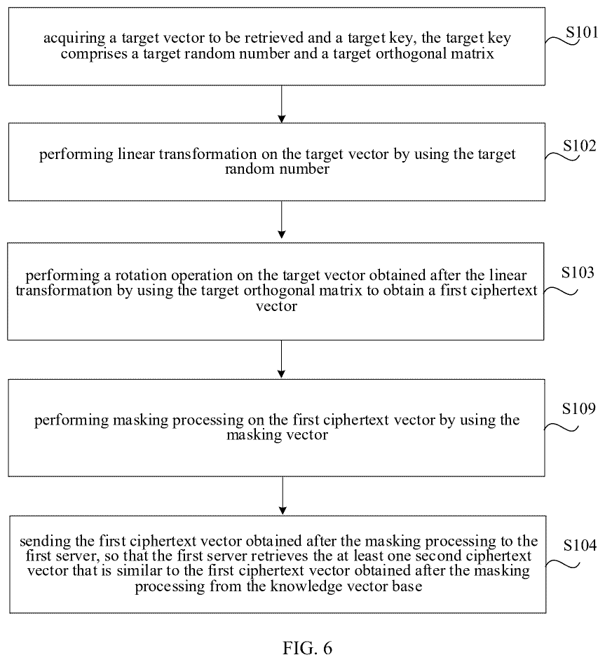

In order to further improve the privacy of the ciphertext vector, after acquiring the first ciphertext vector, masking processing may be performed on it by using a masking vector. Specifically, the above target key may further include the masking vector, as shown in FIG. 6, before the above S104, the above vector retrieval method may further include the following S109.

In S109, the masking processing is performed on the first ciphertext vector by using the masking vector.

At this time, the above S104 may send the first ciphertext vector obtained after the masking processing to the first server, so that the first server retrieves the at least one second ciphertext vector that is similar to the first ciphertext vector obtained after the masking processing from the knowledge vector base.

In addition, a d-dimensional vector may be selected from the vector space a of dimension d to which the target vector belongs as the masking vector, for performing masking processing on the first ciphertext vector.

Exemplarily, the masking processing may be performed on the first ciphertext vector by using the masking vector by using the following equation (5):

$$h = c + t \qquad ( 5 )$$

where h is the first ciphertext vector obtained after the masking processing; and t is the masking vector.

In a possible implementation, the above vector retrieval method may further include the following step.

The at least one second ciphertext vector is decrypted by using the target key in response to receiving the at least one second ciphertext vector sent by the first server.

In an implementation, when the target key includes the target random number and the target orthogonal matrix, the at least one second ciphertext vector may be decrypted by using the target key in the following manner.

For each second ciphertext vector of the at least one second ciphertext vector, first, a rotation operation is performed on the second ciphertext vector by using a transpose matrix of the target orthogonal matrix, to obtain a third ciphertext vector. Then, linear transformation is performed on the third ciphertext vector by using a reciprocal of the target random number, to obtain a plaintext vector corresponding to the second ciphertext vector.

Exemplarily, the rotation operation may be first performed on the second ciphertext vector c1 by using the transpose matrix M^{T} of the target orthogonal matrix, to obtain the third ciphertext vector M^{T}·c1, and then, the linear transformation is performed on the third ciphertext vector M^{T}·c1 by using the reciprocal 1/s of the target random number, to obtain the plaintext vector

$$m 1 = \frac{{M}^{T} \cdot c 1}{s}$$

corresponding to the second ciphertext vector.

In another implementation, when the target key includes the target random number, the target orthogonal matrix, and the first bit string, the at least one second ciphertext vector may be decrypted by using the target key in the following manner.

For each second ciphertext vector of the at least one second ciphertext vector, first, the rotation operation is performed on the second ciphertext vector by using the transpose matrix of the target orthogonal matrix, to obtain a third ciphertext vector. Then, the Gaussian noise is removed from the third ciphertext vector, to obtain a fourth ciphertext vector. Next, the linear transformation is performed on the fourth ciphertext vector by using the reciprocal of the target random number, to obtain the plaintext vector corresponding to the second ciphertext vector.

Exemplarily, the rotation operation may be first performed on the second ciphertext vector c1 by using the transpose matrix M^{T} of the target orthogonal matrix, to obtain the third ciphertext vector M^{T}·c1, and then, the Gaussian noise λₘ is removed from the third ciphertext vector M^{T}·c1, to obtain the fourth ciphertext vector M^{T}·c1−λₘ; finally, the linear transformation is performed on the fourth ciphertext vector by using the reciprocal 1/s of the target random number, to obtain the plaintext vector

$$m 1 = \frac{{M}^{T} \cdot c 1 - {λ}_{m}}{s}$$

corresponding to the second ciphertext vector.

In yet another implementation, when the target key includes the target random number, the target orthogonal matrix, the first bit string, and the masking vector, the at least one second ciphertext vector may be decrypted by using the target key in the following manner.

For each second ciphertext vector of the at least one second ciphertext vector, first, demasking processing is performed on the second ciphertext vector by using the masking vector, to obtain a fifth ciphertext vector. Then, the rotation operation is performed on the fifth ciphertext vector by using the transpose matrix of the target orthogonal matrix, to obtain a sixth ciphertext vector. Next, the Gaussian noise is removed from the sixth ciphertext vector, to obtain a seventh ciphertext vector. Finally, the linear transformation is performed on the seventh ciphertext vector by using the reciprocal of the target random number, to obtain the plaintext vector corresponding to the second ciphertext vector.

Exemplarily, the demasking processing may be first performed on the second ciphertext vector c1 by using the masking vector t, to obtain the fifth ciphertext vector c1−t; then, the rotation operation is performed on the fifth ciphertext vector c1−t by using the transpose matrix M^{T} of the target orthogonal matrix, to obtain the sixth ciphertext vector M^{T}·(c1−t); next, the Gaussian noise λₘ is removed from the sixth ciphertext vector M^{T}·(c1−t), to obtain the seventh ciphertext vector M^{T}·(c1−t)−λₘ; finally, the linear transformation is performed on the seventh ciphertext vector by using the reciprocal 1/s of the target random number, to obtain the plaintext vector

$$m 1 = \frac{{M}^{T} \cdot ( c 1 - t ) - {λ}_{m}}{s}$$

corresponding to the second ciphertext vector.

When the similarity between the first ciphertext vector and each of the ciphertext vectors in the knowledge vector base is measured by using the Euclidean distance, that is, the Euclidean distance retrieval of the plaintext is approximately converted into the Euclidean distance retrieval of the ciphertext, it is assumed that x and z are two plaintext vectors in the knowledge vector base, and ∥x−m∥<∥z−m∥−β is satisfied, and the value range of γ is (0, 0.25], then an inner product ∥cₓ−c∥<∥c_{z}−c∥ may be proved, where ∥x−m∥ characterizes the Euclidean distance between x and m, ∥z−m∥ represents the Euclidean distance between z and m, cₓ is the ciphertext of x, c_{z} is the ciphertext of z, ∥cₓ−c∥ characterizes the Euclidean distance between cₓ and c, and ∥c_{z}−c∥ characterizes the Euclidean distance between c_{z} and c, where x and z are encrypted using the same encryption manner as the target vector.

When the cosine similarity is used to measure the similarity between the first ciphertext vector and each ciphertext vector in the knowledge vector base, that is, the plaintext cosine similarity search is approximately converted into the ciphertext inner product search, assuming that x and z are two plaintext vectors in the knowledge vector base, m is a target vector, and cos(x, m)<cos (z, m)−β and ∥x∥=∥m∥=∥z∥=1 are satisfied, a value range of γ is

$$\frac{( 0 , \sqrt{20}}{2} - 2 ] ,$$

and t is a zero vector, an inner product

$${c}_{x}^{T} \cdot c < {c}_{z}^{T} \cdot c$$

may be proved, where

$${c}_{x}^{T}$$

is a transpose vector of a ciphertext vector of x,

$${c}_{z}^{T}$$

is a transpose vector of a ciphertext vector of z, cos(x,m) represents cosine similarity between x and m, cos(z, m) represents cosine similarity between z and m, ∥x∥ represents a 2-norm of x, ∥m∥ represents a 2-norm of m, and ∥z∥ represents a 2-norm of z.

When the above vector retrieval method is applied to the client, the above S101 may include encoding a text corresponding to an input request to obtain the target vector in response to receiving the text corresponding to the input request. At this time, the above S104 may include: sending the first ciphertext vector to the first server, so that the first server retrieves the at least one second ciphertext vector that is similar to the first ciphertext vector from the knowledge vector base, acquiring at least one ciphertext corresponding to the at least one second ciphertext vector, and sending the at least one second ciphertext vector and the at least one ciphertext to the client. The above vector retrieval method may further include the following two steps.
sending the text corresponding to the input request and the at least one ciphertext to a large language model server to generate a reply text of the text corresponding to the input request by the large language model server by using the at least one ciphertext as prompt information in response to receiving the at least one ciphertext sent by the first server, and sending the reply text to the client; and
receiving and displaying the reply text sent by the large language model server.

In the present disclosure, the large language model is deployed on the large language model server. For a question answering scenario, after retrieving at least one second ciphertext vector that is similar to the first ciphertext vector from the knowledge vector base, the first server may acquire at least one ciphertext corresponding to the at least one second ciphertext vector, and then may send the at least one second ciphertext vector and the at least one ciphertext to the client. After receiving the at least one ciphertext sent by the first server, the client sends the text corresponding to the input request and the at least one ciphertext to the large language model server. After receiving the text corresponding to the input request and the at least one ciphertext, the large language model server may first decrypt the at least one ciphertext, and then, use a plaintext corresponding to the ciphertext as a prompt to generate a reply text of the text corresponding to the input request by using a question answering model (i.e., the large language model), and send the reply text to the client. After receiving the reply text, the client displays the reply text.

The large language model server may perform the decryption operation of the ciphertext in a trusted execution environment, and the client synchronizes an encryption key of the ciphertext to the trusted execution environment of the large language model server. The trusted execution environment may avoid leakage of the target key.

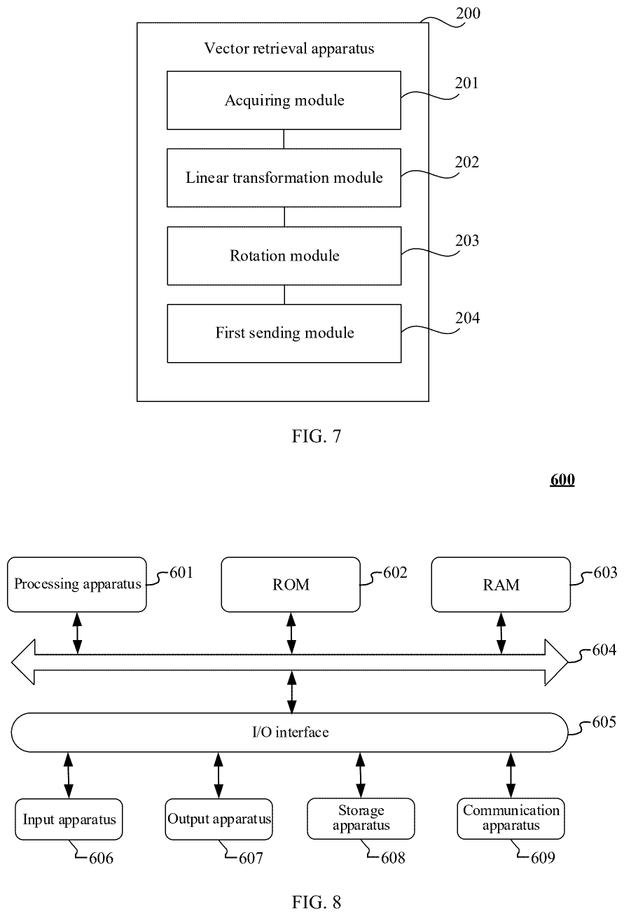

FIG. 7 is a block diagram of a vector retrieval apparatus according to an exemplary embodiment. As shown in FIG. 7, the vector retrieval apparatus 200 includes:
an acquiring module 201, configured to acquire a target vector to be retrieved and a target key, where the target key includes a target random number and a target orthogonal matrix;
a linear transformation module 202, configured to perform linear transformation on the target vector by using the target random number;
a rotation module 203, configured to perform a rotation operation on the target vector obtained after the linear transformation by using the target orthogonal matrix to obtain a first ciphertext vector; and
a first sending module 204, configured to send the first ciphertext vector to a first server, so that the first server retrieves at least one second ciphertext vector that is similar to the first ciphertext vector from a knowledge vector base, where ciphertext vectors in the knowledge vector base are generated based on the target key and a reference vector, and a generation manner of the ciphertext vectors is the same as a generation manner of the first ciphertext vector.

In the above technical solution, before performing vector retrieval on the target vector, linear transformation is first performed on the target vector by using the target random number, and then the rotation operation is performed on the target vector obtained after the linear transformation by using the target orthogonal matrix, to obtain the first ciphertext vector of the target vector. Finally, the first ciphertext vector is sent to the first server, so that the first server retrieves at least one second ciphertext vector that is similar to the first ciphertext vector from the knowledge vector base, where the ciphertext vectors in the knowledge vector base are generated based on the target random number, the target orthogonal matrix, and the reference vector, and the generation manner of the ciphertext vectors is the same as the generation manner of the first ciphertext vector. Since multiplying an orthogonal matrix by a vector has a characteristic of keeping the distance between vectors, performing the rotation operation on the target vector obtained after the linear transformation and the reference vector obtained after the linear transformation by using the orthogonal matrix can make the distance between the first ciphertext vector and the second ciphertext vector close to the distance between the original plaintext vectors, so as to approximately keep the distance between the plaintext vectors, so that retrieval on the ciphertext vectors can be supported as the plaintext vectors support retrieval, and the recall rate is basically unchanged. In addition, the target random number and the target orthogonal matrix are used to encrypt both the target vector and each of the reference vectors in the knowledge vector base, which can mask the information of the original plaintext vectors from two directions, that is, a horizontal direction (linear transformation) and a vertical direction (orthogonal matrix), so that the vec2text attack in the language model service scenario can be resisted and the user's privacy leakage can be avoided on the premise of supporting vector retrieval.

Optionally, the target key further includes a first bit string with a first preset length.

The vector retrieval apparatus 200 further includes:
a first generation module, configured to randomly generate a second bit string with a second preset length before the rotation module 203 performs the rotation operation on the target vector obtained after the linear transformation by using the target orthogonal matrix;
a second generation module, configured to use the first bit string as a key of a preset pseudo-random function, and use the second bit string as an input of the preset pseudo-random function, to obtain a third bit string;
a third generation module, configured to generate Gaussian noise according to the third bit string, a preset approximation factor, and the target random number;
a noise addition module, configured to perform noise addition processing on the target vector obtained after the linear transformation by using the Gaussian noise, to obtain a noise vector; and
the rotation module 203 is configured to perform the rotation operation on the noise vector by using the target orthogonal matrix.

Optionally, the third generation module includes:
a splitting submodule, configured to split the third bit string into a fourth bit string and a fifth bit string based on a preset splitting rule;
a first generation submodule, configured to generate a Gaussian vector with a dimension of d that conforms to a standard normal distribution by using the fourth bit string, and generate a pseudo-random number that conforms to a uniform distribution of (0, 1) by using the fifth bit string, where d is a dimension of the target vector, and d is a natural number greater than 0; and
a second generation submodule, configured to generate Gaussian noise by using the Gaussian vector, the pseudo-random number, a preset approximation factor, and the target random number.

Optionally, the second generation submodule is configured to generate the Gaussian noise by using the Gaussian vector, the pseudo-random number, the preset approximation factor, and the target random number by using a formula as shown below:

$${λ}_{m} = γ \cdot s {β ( {x}^{′} )}^{1 / d} \cdot \frac{u}{‖ u ‖}$$

where λₘ is the Gaussian noise; γ is a scaling factor; β is the preset approximation factor; s is the target random number; x′ is the pseudo-random number; u is the Gaussian vector; and ∥u∥ is a 2-norm of the Gaussian vector.

Optionally, the target key further includes a masking vector.

The vector retrieval apparatus 200 further includes: a masking module, configured to perform masking processing on the first ciphertext vector by using the masking vector before the first sending module 204 sends the first ciphertext vector to the first server.

The first sending module 204 is configured to send the first ciphertext vector obtained after the masking processing to the first server, so that the first server retrieves the at least one second ciphertext vector that is similar to the first ciphertext vector obtained after the masking processing from a knowledge vector base.

Optionally, the vector retrieval apparatus 200 further includes:
a decrypting module, configured to decrypt the at least one second ciphertext vector by using the target key in response to receiving the at least one second ciphertext vector sent by the first server.

Optionally, the decrypting module includes:
a rotating submodule, configured to perform a rotation operation on each second ciphertext vector of the at least one second ciphertext vector by using a transpose matrix of the target orthogonal matrix, to obtain a third ciphertext vector; and
a linear transforming submodule, configured to perform linear transformation on the third ciphertext vector by using a reciprocal of the target random number, to obtain a plaintext vector corresponding to the second ciphertext vector.

Optionally, the vector retrieval apparatus 200 is applied to a client.

The acquiring module is configured to encode the text corresponding to the input request to obtain the target vector in response to receiving the text corresponding to the input request.

The first sending module 204 is configured to send the first ciphertext vector to the first server, so that the first server retrieves the at least one second ciphertext vector that is similar to the first ciphertext vector from the knowledge vector base, acquires at least one ciphertext corresponding to the at least one second ciphertext vector, and sends the at least one second ciphertext vector and the at least one ciphertext to the client.

The vector retrieval apparatus 200 further includes:
a second sending module, configured to send the text corresponding to the input request and the at least one ciphertext to the large language model server to generate a reply text of the text corresponding to the input request by the large language model server by using the at least one ciphertext as prompt information in response to receiving the at least one ciphertext sent by the first server, and send the reply text to the client; and
a receiving module, configured to receive and display the reply text sent by the large language model server.

In addition, the present disclosure further provides a computer-readable medium, a computer program is stored on the computer-readable medium, and the computer program, when executed by a processing apparatus, implements the steps of the above vector retrieval method provided by the present disclosure.

In addition, the present disclosure further provides a computer program product, including a computer program, where the computer program, when executed by a processor, implements the steps of the above vector retrieval method provided by the present disclosure.

Reference is made to FIG. 8 below, which illustrates a schematic structural diagram of an electronic device (such as a terminal device) 600 suitable for implementing the embodiments of the present disclosure. The terminal device in the embodiment of the present disclosure may include, but is not limited to, mobile terminals such as a mobile phone, a notebook computer, a digital broadcast receiver, a personal digital assistant (PDA), a tablet computer, a portable multimedia player (PMP), a vehicle-mounted terminal (such as a vehicle navigation terminal), and fixed terminals such as a digital TV and a desktop computer. The electronic device shown in FIG. 8 is only an example, and should not bring any limitation to the function and usage scope of the embodiments of the present disclosure.

As shown in FIG. 8, the electronic device 600 may include a processing apparatus (such as a central processing unit, a graphics processor, etc.) 601, which may perform various appropriate actions and processing according to a program stored in a read-only memory (ROM) 602 or a program loaded from a storage apparatus 608 into a random access memory (RAM) 603. The RAM 603 also stores various programs and data required for the operation of the electronic device 600. The processing apparatus 601, the ROM 602 and the RAM 603 are connected to each other through a bus 604. An input/output (I/O) interface 605 is also connected to the bus 604.

Generally, the following apparatuses may be connected to the I/O interface 605: an input apparatus 606 including, for example, a touchscreen, a touchpad, a keyboard, a mouse, a camera, a microphone, an accelerometer, a gyroscope, etc.; an output apparatus 607 including, for example, a liquid crystal display (LCD), a speaker, a vibrator, etc.; a storage apparatus 608 including, for example, a magnetic tape, a hard disk, etc.; and a communication apparatus 609. The communication apparatus 609 may allow the electronic device 600 to perform wireless or wired communication with other devices to exchange data. Although FIG. 8 shows the electronic device 600 having various apparatuses, it should be understood that not all of the illustrated apparatuses are required to be implemented or provided. Alternatively, more or fewer apparatuses may be implemented or provided.

In particular, according to the embodiments of the present disclosure, the processes described above with reference to the flowcharts may be implemented as a computer software program. For example, an embodiment of the present disclosure includes a computer program product, which includes a computer program carried on a non-transitory computer-readable medium, and the computer program includes program codes for executing the methods shown in the flowcharts. In such an embodiment, the computer program may be downloaded and installed from a network through the communication apparatus 609, or installed from the storage apparatus 608, or installed from the ROM 602. When the computer program is executed by the processing apparatus 601, the above functions defined in the methods of the embodiments of the present disclosure are executed.

It should be noted that the above computer-readable medium in the present disclosure may be a computer-readable signal medium or a computer-readable storage medium, or any combination thereof. The computer-readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to, an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that contains or stores a program, and the program may be used by or in combination with an instruction execution system, apparatus, or device. In the present disclosure, the computer-readable signal medium may include a data signal propagated in a baseband or as a part of a carrier wave, and computer-readable program codes are carried therein. The data signal propagated in this manner may take a variety of forms, including but not limited to an electromagnetic signal, an optical signal, or any suitable combination thereof. The computer-readable signal medium may also be any computer-readable medium other than the computer-readable storage medium, and the computer-readable signal medium may send, propagate, or transmit a program used by or in combination with an instruction execution system, apparatus, or device. The program codes included on the computer-readable medium may be transmitted by any suitable medium, including but not limited to an electrical wire, an optical fiber cable, radio frequency (RF), etc., or any suitable combination thereof.

In some implementations, the client may communicate using any currently known or future-developed network protocol such as the hypertext transfer protocol (HTTP), and may be interconnected with any form or medium of digital data communication (for example, a communication network). Examples of the communication network include a local area network (“LAN”), a wide area network (“WAN”), an inter-network (for example, the Internet), and a peer-to-peer network (for example, an ad hoc peer-to-peer network), as well as any currently known or future-developed network.

The above computer-readable medium may be included in the above electronic device, or may exist alone without being assembled into the electronic device.

The above computer-readable medium carries one or more programs, and when the above one or more programs are executed by the electronic device, the electronic device is caused to: acquire a target vector to be retrieved and a target key, where the target key includes a target random number and a target orthogonal matrix; perform linear transformation on the target vector by using the target random number; perform a rotation operation on the target vector obtained after the linear transformation by using the target orthogonal matrix to obtain a first ciphertext vector; and send the first ciphertext vector to a first server, so that the first server retrieves at least one second ciphertext vector that is similar to the first ciphertext vector from a knowledge vector base, where ciphertext vectors in the knowledge vector base are generated based on the target key and a reference vector, and a generation manner of the ciphertext vectors is the same as a generation manner of the first ciphertext vector.

The computer program codes for performing the operations of the present disclosure may be written in one or more programming languages or a combination thereof. The above programming languages include object-oriented programming languages, such as Java, Smalltalk, C++, and also include conventional procedural programming languages, such as “C” language or similar programming languages. The program codes may be executed entirely on the user's computer, partly on the user's computer, as a stand-alone software package, partly on the user's computer and partly on a remote computer, or entirely on the remote computer or server. In the case of the remote computer, the remote computer may be connected to the user's computer through any kind of network, including a local area network (LAN) or a wide area network (WAN), or the connection may be made to an external computer (for example, through the Internet using an Internet service provider).

The flowcharts and block diagrams in the drawings illustrate the architecture, functionality, and operation of possible implementations of the systems, methods, and computer program products according to various embodiments of the present disclosure. In this regard, each block in the flowcharts or block diagrams may represent a module, a program segment, or a portion of codes, and the module, the program segment, or the portion of codes contains one or more executable instructions for implementing the specified logical function. It should also be noted that in some alternative implementations, the functions noted in the blocks may also occur out of the order noted in the drawings. For example, two blocks shown in succession may, in fact, be executed substantially concurrently, or the blocks may sometimes be executed in a reverse order, depending upon the functionality involved. It should also be noted that each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules involved in the embodiments of the present disclosure may be implemented by software or hardware. The name of the module does not constitute a limitation on the module itself under certain circumstances. For example, the acquiring module may also be described as “a module for acquiring a target vector to be retrieved and a target key”.

The functions described herein above may be performed at least in part by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logic device (CPLD), etc.

In the context of the present disclosure, a machine-readable medium may be a tangible medium that may contain or store a program for use by or in connection with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

According to one or more embodiments of the present disclosure, Example 1 provides a vector retrieval method, including:
acquiring a target vector to be retrieved and a target key, where the target key includes a target random number and a target orthogonal matrix;
performing linear transformation on the target vector by using the target random number;
performing a rotation operation on the target vector obtained after the linear transformation by using the target orthogonal matrix to obtain a first ciphertext vector; and
sending the first ciphertext vector to a first server, so that the first server retrieves at least one second ciphertext vector that is similar to the first ciphertext vector from a knowledge vector base, where ciphertext vectors in the knowledge vector base are generated based on the target key and a reference vector, and a generation manner of the ciphertext vectors is the same as a generation manner of the first ciphertext vector.

According to one or more embodiments of the present disclosure, Example 2 provides the method of Example 1, the target key further includes a first bit string with a first preset length;
before the step of performing the rotation operation on the target vector obtained after the linear transformation by using the target orthogonal matrix, the method further includes:
randomly generating a second bit string with a second preset length;
using the first bit string as a key of a preset pseudo-random function, and using the second bit string as an input of the preset pseudo-random function, to obtain a third bit string;
generating Gaussian noise according to the third bit string, a preset approximation factor, and the target random number;
performing noise addition processing on the target vector obtained after the linear transformation by using the Gaussian noise, to obtain a noise vector; and
the step of performing the rotation operation on the target vector obtained after the linear transformation by using the target orthogonal matrix includes:
performing the rotation operation on the noise vector by using the target orthogonal matrix.

According to one or more embodiments of the present disclosure, Example 3 provides the method of Example 2, the step of generating the Gaussian noise according to the third bit string, the preset approximation factor, and the target random number includes:
splitting the third bit string into a fourth bit string and a fifth bit string based on a preset splitting rule;
generating a Gaussian vector with a dimension of d that conforms to a standard normal distribution by using the fourth bit string, and generating a pseudo-random number that conforms to a uniform distribution of (0, 1) by using the fifth bit string, where d is a dimension of the target vector, and d is a natural number greater than 0; and
generating the Gaussian noise by using the Gaussian vector, the pseudo-random number, the preset approximation factor, and the target random number.

According to one or more embodiments of the present disclosure, Example 4 provides the method of Example 3, the step of generating the Gaussian noise by using the Gaussian vector, the pseudo-random number, the preset approximation factor, and the target random number includes:
generating the Gaussian noise by using the Gaussian vector, the pseudo-random number, the preset approximation factor, and the target random number by using a formula as shown below:

$${λ}_{m} = γ \cdot s {β ( {x}^{′} )}^{1 / d} \cdot \frac{u}{‖ u ‖}$$

where λₘ is the Gaussian noise; γ is a scaling factor; β is the preset approximation factor; s is the target random number; x′ is the pseudo-random number; u is the Gaussian vector; and ∥u∥ is a 2-norm of the Gaussian vector.

According to one or more embodiments of the present disclosure, Example 5 provides the method of any one of Examples 1-4, the target key further includes a masking vector;
before the step of sending the first ciphertext vector to the first server, the method further includes:
performing masking processing on the first ciphertext vector by using the masking vector;
the step of sending the first ciphertext vector to the first server, so that the first server retrieves the at least one second ciphertext vector that is similar to the first ciphertext vector from a knowledge vector base includes:
sending the first ciphertext vector obtained after the masking processing to the first server, so that the first server retrieves the at least one second ciphertext vector that is similar to the first ciphertext vector obtained after the masking processing from the knowledge vector base.

According to one or more embodiments of the present disclosure, Example 6 provides the method of Example 1, the method further includes:
decrypting the at least one second ciphertext vector by using the target key in response to receiving the at least one second ciphertext vector sent by the first server.

According to one or more embodiments of the present disclosure, Example 7 provides the method of Example 6, the step of decrypting the at least one second ciphertext vector by using the target key includes:
performing a rotation operation on each second ciphertext vector of the at least one second ciphertext vector by using a transpose matrix of the target orthogonal matrix, to obtain a third ciphertext vector; and
performing linear transformation on the third ciphertext vector by using a reciprocal of the target random number, to obtain a plaintext vector corresponding to the second ciphertext vector.

According to one or more embodiments of the present disclosure, Example 8 provides the method of any one of Examples 1-4, and the method is applied to a client;
the step of acquiring the target vector to be retrieved includes:
encoding a text corresponding to an input request to obtain the target vector in response to receiving the text corresponding to the input request;
the step of sending the first ciphertext vector to the first server, so that the first server retrieves the at least one second ciphertext vector that is similar to the first ciphertext vector from a knowledge vector base includes:
sending the first ciphertext vector to the first server, so that the first server retrieves the at least one second ciphertext vector that is similar to the first ciphertext vector from the knowledge vector base, acquiring at least one ciphertext corresponding to the at least one second ciphertext vector, and sending the at least one second ciphertext vector and the at least one ciphertext to the client;
the method further includes:
sending the text and the at least one ciphertext to a large language model server to generate a reply text of the text by the large language model server by using the at least one ciphertext as prompt information in response to receiving the at least one ciphertext sent by the first server, and sending the reply text to the client; and
receiving and displaying the reply text sent by the large language model server.

According to one or more embodiments of the present disclosure, Example 9 provides a vector retrieval apparatus, including:
an acquiring module, configured to acquire a target vector to be retrieved and a target key, where the target key includes a target random number and a target orthogonal matrix;
a linear transformation module, configured to perform linear transformation on the target vector by using the target random number;
a rotation module, configured to perform a rotation operation on the target vector obtained after the linear transformation by using the target orthogonal matrix to obtain a first ciphertext vector; and
a first sending module, configured to send the first ciphertext vector to a first server, so that the first server retrieves at least one second ciphertext vector that is similar to the first ciphertext vector from a knowledge vector base, where ciphertext vectors in the knowledge vector base are generated based on the target key and a reference vector, and a generation manner of the ciphertext vectors is the same as a generation manner of the first ciphertext vector.

According to one or more embodiments of the present disclosure, Example 10 provides a computer-readable medium, a computer program is stored on the computer-readable medium, and the computer program, when executed by a processing apparatus, implements the steps of the method according to any one of Examples 1-8.

According to one or more embodiments of the present disclosure, Example 11 provides an electronic device, including:
a storage apparatus, a computer program is stored on the storage apparatus; and
a processing apparatus, configured to execute the computer program in the storage apparatus to implement the steps of the method according to any one of Examples 1-8.

According to one or more embodiments of the present disclosure, Example 12 provides a computer program product, including a computer program, where the computer program, when executed by a processor, implements the steps of the method according to any one of Examples 1 to 8.

The above description is merely preferred embodiments of the present disclosure and the explanation of the applied technical principles. It should be understood by those skilled in the art that the scope of disclosure involved in the present disclosure is not limited to the technical solution formed by the specific combination of the above technical features, and should also cover other technical solutions formed by arbitrarily combining the above technical features or equivalent features thereof without departing from the above disclosed concept. For example, the technical solution formed by replacing the above features with (but not limited to) the technical features having similar functions disclosed in the present disclosure.

In addition, although operations are depicted in a particular order, this should not be understood as requiring these operations to be performed in the specific order shown or in a sequential order. Under certain circumstances, multitasking and parallel processing may be advantageous. Likewise, although the above discussion contains several specific implementation details, these should not be interpreted as limiting the scope of the present disclosure. Certain features that are described in the context of separate embodiments may also be implemented in combination in a single embodiment. Conversely, various features described in the context of a single embodiment may also be implemented in multiple embodiments individually or in any suitable sub-combination.

Although the subject matter has been described in language specific to structural features and/or logical actions of methods, it should be understood that the subject matter defined in the appended claims is not necessarily limited to the specific features or actions described above. Rather, the specific features and actions described above are merely example forms for implementing the claims. Regarding the apparatuses in the above embodiments, the specific manners in which the respective modules perform operations have been described in detail in the embodiments related to the method, and are not described in detail here.

1. A vector retrieval method, comprising:
acquiring a target vector to be retrieved and a target key, wherein the target key comprises a target random number and a target orthogonal matrix;
performing linear transformation on the target vector by using the target random number;
performing a rotation operation on the target vector obtained after the linear transformation by using the target orthogonal matrix to obtain a first ciphertext vector; and
sending the first ciphertext vector to a first server, so that the first server retrieves at least one second ciphertext vector that is similar to the first ciphertext vector from a knowledge vector base, wherein ciphertext vectors in the knowledge vector base are generated based on the target key and a reference vector, and a generation manner of the ciphertext vectors is the same as a generation manner of the first ciphertext vector.

2. The method according to claim 1, wherein the target key further comprises a first bit string with a first preset length; and
before the step of performing the rotation operation on the target vector obtained after the linear transformation by using the target orthogonal matrix, the method further comprises:
randomly generating a second bit string with a second preset length;
using the first bit string as a key of a preset pseudo-random function, and using the second bit string as an input of the preset pseudo-random function, to obtain a third bit string;
generating Gaussian noise according to the third bit string, a preset approximation factor, and the target random number;
performing noise addition processing on the target vector obtained after the linear transformation by using the Gaussian noise, to obtain a noise vector; and
the step of performing the rotation operation on the target vector obtained after the linear transformation by using the target orthogonal matrix comprises:
performing the rotation operation on the noise vector by using the target orthogonal matrix.

3. The method according to claim 2, wherein the step of generating the Gaussian noise according to the third bit string, the preset approximation factor, and the target random number comprises:
splitting the third bit string into a fourth bit string and a fifth bit string based on a preset splitting rule;
generating a Gaussian vector with a dimension of d that conforms to a standard normal distribution by using the fourth bit string, and generating a pseudo-random number that conforms to a uniform distribution of (0, 1) by using the fifth bit string, wherein d is a dimension of the target vector, and d is a natural number greater than 0; and
generating the Gaussian noise by using the Gaussian vector, the pseudo-random number, the preset approximation factor, and the target random number.

4. The method according to claim 3, wherein the step of generating the Gaussian noise by using the Gaussian vector, the pseudo-random number, the preset approximation factor, and the target random number comprises:
generating the Gaussian noise by using the Gaussian vector, the pseudo-random number, the preset approximation factor, and the target random number by using a formula as shown below:
$${λ}_{m} = γ \cdot s {β ( {x}^{′} )}^{1 / d} \cdot \frac{u}{‖ u ‖}$$
wherein λₘ is the Gaussian noise; γ is a scaling factor; β is the preset approximation factor; s is the target random number; x′ is the pseudo-random number; u is the Gaussian vector; and ∥u∥ is a 2-norm of the Gaussian vector.

5. The method according to claim 1, wherein the target key further comprises a masking vector; and
before the step of sending the first ciphertext vector to the first server, the method further comprises:
performing masking processing on the first ciphertext vector by using the masking vector; and
the step of sending the first ciphertext vector to the first server, so that the first server retrieves the at least one second ciphertext vector that is similar to the first ciphertext vector from a knowledge vector base comprises:
sending the first ciphertext vector obtained after the masking processing to the first server, so that the first server retrieves the at least one second ciphertext vector that is similar to the first ciphertext vector obtained after the masking processing from the knowledge vector base.

6. The method according to claim 2, wherein the target key further comprises a masking vector; and
before the step of sending the first ciphertext vector to the first server, the method further comprises:
performing masking processing on the first ciphertext vector by using the masking vector; and
the step of sending the first ciphertext vector to the first server, so that the first server retrieves the at least one second ciphertext vector that is similar to the first ciphertext vector from a knowledge vector base comprises:
sending the first ciphertext vector obtained after the masking processing to the first server, so that the first server retrieves the at least one second ciphertext vector that is similar to the first ciphertext vector obtained after the masking processing from the knowledge vector base.

7. The method according to claim 3, wherein the target key further comprises a masking vector; and
before the step of sending the first ciphertext vector to the first server, the method further comprises:
performing masking processing on the first ciphertext vector by using the masking vector; and
the step of sending the first ciphertext vector to the first server, so that the first server retrieves the at least one second ciphertext vector that is similar to the first ciphertext vector from a knowledge vector base comprises:
sending the first ciphertext vector obtained after the masking processing to the first server, so that the first server retrieves the at least one second ciphertext vector that is similar to the first ciphertext vector obtained after the masking processing from the knowledge vector base.

8. The method according to claim 4, wherein the target key further comprises a masking vector; and
before the step of sending the first ciphertext vector to the first server, the method further comprises:
performing masking processing on the first ciphertext vector by using the masking vector; and
the step of sending the first ciphertext vector to the first server, so that the first server retrieves the at least one second ciphertext vector that is similar to the first ciphertext vector from a knowledge vector base comprises:
sending the first ciphertext vector obtained after the masking processing to the first server, so that the first server retrieves the at least one second ciphertext vector that is similar to the first ciphertext vector obtained after the masking processing from the knowledge vector base.

9. The method according to claim 1, further comprising:
decrypting the at least one second ciphertext vector by using the target key in response to receiving the at least one second ciphertext vector sent by the first server.

10. The method according to claim 9, wherein the step of decrypting the at least one second ciphertext vector by using the target key comprises:
performing a rotation operation on each second ciphertext vector of the at least one second ciphertext vector by using a transpose matrix of the target orthogonal matrix, to obtain a third ciphertext vector; and
performing linear transformation on the third ciphertext vector by using a reciprocal of the target random number, to obtain a plaintext vector corresponding to the second ciphertext vector.

11. The method according to claim 1, wherein the method is applied to a client;
the step of acquiring the target vector to be retrieved comprises:
encoding a text corresponding to an input request to obtain the target vector in response to receiving the text corresponding to the input request;
the step of sending the first ciphertext vector to the first server, so that the first server retrieves the at least one second ciphertext vector that is similar to the first ciphertext vector from the knowledge vector base comprises:
sending the first ciphertext vector to the first server, so that the first server retrieves the at least one second ciphertext vector that is similar to the first ciphertext vector from the knowledge vector base, acquiring at least one ciphertext corresponding to the at least one second ciphertext vector, and sending the at least one second ciphertext vector and the at least one ciphertext to the client; and
the method further comprises:
sending the text and the at least one ciphertext to a large language model server to generate a reply text of the text by the large language model server by using the at least one ciphertext as prompt information in response to receiving the at least one ciphertext sent by the first server, and sending the reply text to the client; and
receiving and displaying the reply text sent by the large language model server.

12. The method according to claim 2, wherein the method is applied to a client;
the step of acquiring the target vector to be retrieved comprises:
encoding a text corresponding to an input request to obtain the target vector in response to receiving the text corresponding to the input request;
the step of sending the first ciphertext vector to the first server, so that the first server retrieves the at least one second ciphertext vector that is similar to the first ciphertext vector from the knowledge vector base comprises:
sending the first ciphertext vector to the first server, so that the first server retrieves the at least one second ciphertext vector that is similar to the first ciphertext vector from the knowledge vector base, acquiring at least one ciphertext corresponding to the at least one second ciphertext vector, and sending the at least one second ciphertext vector and the at least one ciphertext to the client; and
the method further comprises:
sending the text and the at least one ciphertext to a large language model server to generate a reply text of the text by the large language model server by using the at least one ciphertext as prompt information in response to receiving the at least one ciphertext sent by the first server, and sending the reply text to the client; and
receiving and displaying the reply text sent by the large language model server.

13. The method according to claim 3, wherein the method is applied to a client;
the step of acquiring the target vector to be retrieved comprises:
encoding a text corresponding to an input request to obtain the target vector in response to receiving the text corresponding to the input request;
the step of sending the first ciphertext vector to the first server, so that the first server retrieves the at least one second ciphertext vector that is similar to the first ciphertext vector from the knowledge vector base comprises:
sending the first ciphertext vector to the first server, so that the first server retrieves the at least one second ciphertext vector that is similar to the first ciphertext vector from the knowledge vector base, acquiring at least one ciphertext corresponding to the at least one second ciphertext vector, and sending the at least one second ciphertext vector and the at least one ciphertext to the client; and
the method further comprises:
sending the text and the at least one ciphertext to a large language model server to generate a reply text of the text by the large language model server by using the at least one ciphertext as prompt information in response to receiving the at least one ciphertext sent by the first server, and sending the reply text to the client; and
receiving and displaying the reply text sent by the large language model server.

14. The method according to claim 4, wherein the method is applied to a client;
the step of acquiring the target vector to be retrieved comprises:
encoding a text corresponding to an input request to obtain the target vector in response to receiving the text corresponding to the input request;
the step of sending the first ciphertext vector to the first server, so that the first server retrieves the at least one second ciphertext vector that is similar to the first ciphertext vector from the knowledge vector base comprises:
sending the first ciphertext vector to the first server, so that the first server retrieves the at least one second ciphertext vector that is similar to the first ciphertext vector from the knowledge vector base, acquiring at least one ciphertext corresponding to the at least one second ciphertext vector, and sending the at least one second ciphertext vector and the at least one ciphertext to the client; and
the method further comprises:
sending the text and the at least one ciphertext to a large language model server to generate a reply text of the text by the large language model server by using the at least one ciphertext as prompt information in response to receiving the at least one ciphertext sent by the first server, and sending the reply text to the client; and
receiving and displaying the reply text sent by the large language model server.

15. A computer-readable medium, wherein a computer program is stored on the computer-readable medium, and the computer program, when executed by a processing apparatus, implements:
acquiring a target vector to be retrieved and a target key, wherein the target key comprises a target random number and a target orthogonal matrix;
performing linear transformation on the target vector by using the target random number;
performing a rotation operation on the target vector obtained after the linear transformation by using the target orthogonal matrix to obtain a first ciphertext vector; and
sending the first ciphertext vector to a first server, so that the first server retrieves at least one second ciphertext vector that is similar to the first ciphertext vector from a knowledge vector base, wherein ciphertext vectors in the knowledge vector base are generated based on the target key and a reference vector, and a generation manner of the ciphertext vectors is the same as a generation manner of the first ciphertext vector.

16. An electronic device, comprising:
a storage apparatus, wherein a computer program is stored on the storage apparatus; and
a processing apparatus, configured to execute the computer program in the storage apparatus to implement:
acquiring a target vector to be retrieved and a target key, wherein the target key comprises a target random number and a target orthogonal matrix;
performing linear transformation on the target vector by using the target random number;
performing a rotation operation on the target vector obtained after the linear transformation by using the target orthogonal matrix to obtain a first ciphertext vector; and
sending the first ciphertext vector to a first server, so that the first server retrieves at least one second ciphertext vector that is similar to the first ciphertext vector from a knowledge vector base, wherein ciphertext vectors in the knowledge vector base are generated based on the target key and a reference vector, and a generation manner of the ciphertext vectors is the same as a generation manner of the first ciphertext vector.

17. The electronic device according to claim 16, wherein the target key further comprises a first bit string with a first preset length; and
before the step of performing the rotation operation on the target vector obtained after the linear transformation by using the target orthogonal matrix, the processing apparatus is further configured to execute the computer program in the storage apparatus to implement:
randomly generating a second bit string with a second preset length;
using the first bit string as a key of a preset pseudo-random function, and using the second bit string as an input of the preset pseudo-random function, to obtain a third bit string;
generating Gaussian noise according to the third bit string, a preset approximation factor, and the target random number;
performing noise addition processing on the target vector obtained after the linear transformation by using the Gaussian noise, to obtain a noise vector; and
the step of performing the rotation operation on the target vector obtained after the linear transformation by using the target orthogonal matrix comprises:
performing the rotation operation on the noise vector by using the target orthogonal matrix.

18. The electronic device according to claim 16, wherein the target key further comprises a masking vector; and
before the step of sending the first ciphertext vector to the first server, the processing apparatus is further configured to execute the computer program in the storage apparatus to implement:
performing masking processing on the first ciphertext vector by using the masking vector; and
the step of sending the first ciphertext vector to the first server, so that the first server retrieves the at least one second ciphertext vector that is similar to the first ciphertext vector from a knowledge vector base comprises:
sending the first ciphertext vector obtained after the masking processing to the first server, so that the first server retrieves the at least one second ciphertext vector that is similar to the first ciphertext vector obtained after the masking processing from the knowledge vector base.

19. The electronic device according to claim 16, wherein the processing apparatus is further configured to execute the computer program in the storage apparatus to implement:
decrypting the at least one second ciphertext vector by using the target key in response to receiving the at least one second ciphertext vector sent by the first server.

20. A computer program product, comprising a computer program, wherein the computer program, when executed by a processor, implements steps of the method according to claim 1.
